(19) United States
(12) Patent Application Publication
(10) Pub. No.: US 2026/0028788 A1
(43) Pub. Date: Jan. 29, 2026

(54) Dam with Contaminants Entombing Cap

(71) Applicant: W.L. French Hydropower Holdings LLC, Chelmsford, MA (US)

(72) Inventor: William L. French, SR., Lexington, MA (US)

(21) Appl. No.: 19/281,549

(22) Filed: Jul. 25, 2025

Related U.S. Application Data
(60) Provisional application No. 63/676,266, filed on Jul. 26, 2024.

(51) Int. Cl. E02B 3/10; C02F 1/28; E02B 8/08

(52) U.S. Cl. CPC E02B 3/10; C02F 1/28; E02B 8/085

(57) ABSTRACT

Aspects of inventive concepts are directed to a dam system for entombing contaminants in a river. The dam system may include a preexisting structure, a dam, and a cap. The preexisting structure may be in the river and have associated therewith a contamination zone defined by a location of contaminants. The dam may be constructed upriver or downriver of the preexisting structure. The cap may be coupled to the preexisting structure and the dam. The cap may span and entomb the contaminants in at least a portion of the contamination zone.

### RELATED APPLICATION

This application claims the benefit of U.S. Provisional Application No. 63/676,266, filed on Jul. 26, 2024. The entire teachings of the above application are incorporated herein by reference.

### BACKGROUND

Differential hydrostatic pressures that may result after removing a decaying structure can move contaminated underground plumes into waterway, contaminating a clean water supply. Additionally, the cost of removing a decaying structure and hazardous material associated with the decaying structure can greatly surpass the costs of installing a dam in front of the decaying structure.

### SUMMARY

Aspects of inventive concepts are directed to a dam system for entombing contaminants in a river. The dam system may include a preexisting structure, a dam, and a cap. The preexisting structure may be in the river and have associated therewith a contamination zone defined by a location of contaminants. The dam may be constructed upriver or downriver of the preexisting structure. The cap may be coupled to the preexisting structure and the dam. The cap may span and entomb the contaminants in at least a portion of the contamination zone.

The preexisting structure may include a preexisting dam.

The cap may extend from a first riverbank to a second riverbank, the first riverbank and the second riverbank being on different sides of the river.

The dam may include at least one precast segment.

The cap may include at least one precast segment. In such embodiments, filler is used between a precast segment and an adjacent structure (for example, another precast segment). In some embodiments, the filler may be an impermeable filler.

The dam system may further include a stabilizing blanket, the stabilizing blanket being positioned between the cap and the contaminants.

A region between the preexisting structure and the dam may include an impermeable fill.

The cap may be positioned over at least a portion of the impermeable fill.

The dam may include a pneumatic crest gate.

The dam system may further include a powerhouse, the powerhouse being functionally coupled with the dam.

The dam system may further include a fish ladder associated with the dam.

Aspects of inventive concepts are directed to a method for entombing contaminants in a river. The method may include constructing a dam adjacent to a preexisting structure; and applying a cap over the preexisting structure and contaminants associated with the preexisting structure to entomb the contaminants in the river. Applying the cap may include coupling a first end of the cap to a riverbed; and coupling a second end of the cap to the dam.

The dam may include at least one precast segment.

The method may further include stabilizing the contaminants using a binding agent.

The method may further include covering the contaminants with a stabilizing blanket.

The method may further include adding impermeable fill between the preexisting structure and the dam.

The method may further include functionally coupling the dam with a powerhouse.

The method may further include assembling a fish ladder or other animal passageway at the dam to enable fish or other animals to travel upriver and downriver of the dam.

The method may further include removing a top portion of the preexisting structure before applying the cap.

Aspects of inventive concepts are directed to a dam system for entombing contaminants in a river. The dam system may include a dam and means for entombing the contaminants. The dam may be coupled to a riverbed and obstruct water flow for at least a portion of a width of the river. The dam may be adjacent to a preexisting structure and contaminants.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a perspective view of an example embodiment of a dam system.

FIG. 2A shows an example of a first dam in a waterway.

FIG. 2B shows an example of a first dam in decay and holding back contaminants or hazardous material.

FIG. 2C shows an example embodiment in which water has been retained on both sides of the first and second dams so that the second dam can be constructed.

FIG. 2D shows an example embodiment of a second dam in front of a decaying first dam.

FIG. 2E shows an example embodiment of a stabilizing blanket (also referred to as a retention fabric) positioned over treated contaminants.

FIG. 2F shows an example embodiment of a cap entombing the contaminated material and the decaying dam.

FIG. 2G shows an example embodiment of a dam system in which the second dam includes a pneumatic gate.

FIG. 2H shows an example embodiment of a dam system with a second dam in a waterway.

FIG. 3A shows an example embodiment of a second dam in a waterway.

FIG. 3B shows an example method for treating contaminated material.

FIG. 3C shows an example embodiment of a retrofit precast modular dam (second dam) in a waterway with a regular water level.

FIG. 3D shows an example embodiment of a retrofit precast modular dam (second dam) in a waterway with a low water level.

FIG. 4 shows an example embodiment of a second dam with a pneumatic crest gate in a waterway.

FIG. 5 is a perspective view of an example embodiment of a dam system with a powerhouse.

FIG. 6 shows a perspective view from a downstream side of an example embodiment of a powerhouse coupled to a second dam with a pneumatic crest gate.

FIG. 7 shows a perspective view from a downstream side of an example embodiment of a powerhouse coupled to a second dam with a pneumatic crest gate.

FIG. 8A shows a perspective view from an upstream side of an example embodiment of a powerhouse coupled to a second dam with a pneumatic crest gate.

FIG. 8B shows an example embodiment of a first dam near contaminated material and a second dam coupled to a powerhouse.

FIG. 8C shows the example embodiment from FIG. 8B with a retention fabric over the contaminated material.

FIG. 8D shows the example embodiment from FIG. 8C with a cover over the retention fabric.

FIG. 9A shows a decaying first dam in a waterway.

FIG. 9B shows an example of a drained waterway with contaminants near a decaying first dam and a new second dam.

FIG. 9C shows an example of a drained waterway with a new modular precast dam and a cap, the cap entombing contaminants and a decaying dam.

FIG. 9D shows an example of a new modular precast dam in a waterway.

FIG. 9E shows an example of a new modular precast dam with a pneumatic crest gate in a waterway.

FIG. 10 shows an example embodiment of a dam system that includes a new modular precast dam, and contaminants are retained behind a decaying dam.

FIG. 11A shows an example of an existing dam (a first dam) in a waterway.

FIG. 11B shows an example of a first dam in decay and holding back contaminants or hazardous material in the soil.

FIG. 11C shows an example of a first dam holding back contaminants, a drained waterway, and an example embodiment of a second dam.

FIG. 11D shows an example embodiment of a second dam in front of a decaying first dam.

FIG. 11E shows an example embodiment of a stabilizing blanket positioned over treated contaminants.

FIG. 11F shows an example embodiment of a cap entombing the fill and level with a top of the decaying dam.

FIG. 11G shows an example embodiment of a dam system in which the second dam includes a pneumatic gate.

FIG. 11H shows an example embodiment of a dam system with a second dam in a waterway.

FIG. 12A shows an example modular precast dam in a waterway.

FIG. 12B shows an example of the two-step treatment of contaminated material.

FIG. 12C shows an example embodiment of a precast modular dam in a waterway with a low water level.

FIG. 12D shows an example embodiment of a precast modular dam in a waterway with a regular water level.

FIG. 13 shows an example embodiment of a modular precast dam in front of decaying dam and restraining the contaminants behind the decaying dam.

FIG. 14 shows an example embodiment of a second dam with precast segments that is coupled to a fishway.

FIG. 15 shows an upstream view of an example embodiment of a pool & weir fishway coupled to a second dam.

FIG. 16 shows a downstream view of an example embodiment of a pool & weir fishway coupled to a second dam and including an oxygenation attraction system.

FIG. 17 shows an example embodiment of a fishway coated with liner to mimic the texture of natural rock.

FIG. 18A is a perspective view of an example embodiment of a fishway with sloped modular blocks designed according to USFWS specifications for small salmonids.

FIG. 18B is a top view of an example embodiment of a fishway with modular blocks designed according to USFWS specifications for small salmonids.

FIG. 19A is a perspective view of an example embodiment of a fishway.

FIG. 19B is a side view of an example embodiment of a fishway.

### DETAILED DESCRIPTION

A description of example embodiments follows.

Removing a decaying structure, such as an old dam, may cause river flows to spread contaminants into a clean water supply. This problem can be avoided by entombing or encapsulating the contaminants and/or the decaying structure and constructing a new dam to control water flow. In an example embodiment, the new dam may be constructed, at least in part, using precast segments or forms having filler or precast segments disposed therein.

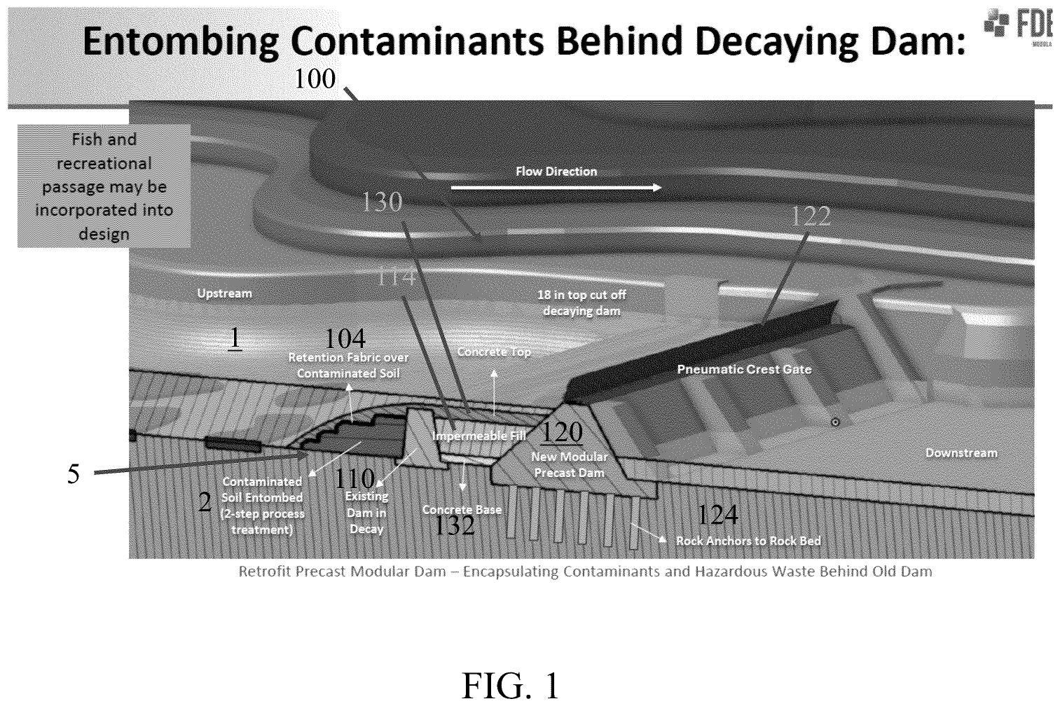

FIG. 1 is a perspective view of an example embodiment of a dam system 100. In some embodiments, such as the one shown in FIG. 1, the dam system 100 includes a cap 130 constructed and arranged to be positioned over a preexisting structure, for example a first (preexisting) dam 110. The cap 130 may also entomb treated or untreated contaminants 2 located near the preexisting dam 110. In some example embodiments, the cap includes concrete. In alternative embodiments, the cap may include a different material.

In some example embodiments, the cap may have a thickness between 10 inches and 2 feet (inclusive of the boundaries of the range). In alternative example embodiments, the cap may have a different thickness.

In some example embodiments, the cap includes concrete with a compressive strength between 3,000-14,000 pounds per square inch (inclusive of the boundaries of the range). In alternative embodiments, the compressive strength may be different.

In some example embodiments, one or more cutoff walls may be used to prevent water from penetrating under the cap.

The cap may be configured to entomb contaminants such that the contaminants are not in fluidic contact with the waterway. In some example embodiments, the cap is configured to allow only an acceptable level of contaminants to be in fluidic contact with the waterway. In some example embodiments, nanomaterials or other waterproofing techniques may be employed to reduce passage of contaminants through the cap.

In some example embodiments, at least one retention fabric 104 may be positioned over treated or untreated contaminants. The retention fabric 104 may be positioned below the cap 130. In some example embodiments, the fabric may be configured so that silk cannot pass through it. In some example embodiments the fabric may be configured to only allow a portion of silk to pass through it. In some example embodiments, the fabric may include a high-strength plastic filter. In some example embodiments, the fabric may include a geotextile material.

A region of contaminants may be referred to as a contamination zone 5. In some instances, the boundaries of the contamination zone are defined by a threshold level of contaminants. In some embodiments, the threshold level is determined using concentration measurements. In such embodiments, if the concentration of contaminants in a location exceeds the threshold, the location is in the contamination zone. In some instances, the threshold may be in accordance with state and/or federal thresholds.

In alternative embodiments, the threshold level of contaminants may be determined using a different measurement technique.

Some or all of the contamination zone may be inside the preexisting structure. Some or all of the contamination zone may be upstream of the preexisting structure. Some or all of the contamination zone may be downstream of the preexisting structure.

In some example embodiments, prior to applying the cap 130, a portion of the top of the first dam 110 may be removed. In the embodiment shown in FIG. 1, about 18 inches is removed from the top of the first dam 110. In alternative embodiments, a different amount may be removed. In some embodiments, no material may be removed from the first dam.

The dam system 100 may include a second (newly constructed) dam 120. The second dam 120 may include at least one precast segment. A base of the second dam 120 may be coupled to a portion of the cap 130. A base of the second dam 120 may be near a portion of the cap 130. As shown in FIG. 1, the second dam 120 may be coupled to a crest gate 122, for example a pneumatic crest gate. Additionally, or alternatively, the dam may include a different type of gate. The gate may be any length or height.

The second dam 120 may include one or more rock anchors 124, or any similar mechanism, for securing the second dam 120 to a lower surface, such as bedrock (not shown) beneath the riverbed. In some example embodiments, the cap is coupled to one or more of the one or more rock anchors 124.

In some example embodiments, such as the embodiment shown in FIG. 1, the second dam is downstream of the contamination zone 5. In alternative embodiments, the second dam may be upstream of the contamination zone.

In some example embodiments, such as the embodiment shown in FIG. 1, the cap covers the preexisting structure. In alternative embodiments, a height of a top surface of the cap is aligned with a height of a top surface of the preexisting structure. In some example embodiments, the cap may not cover the preexisting structure.

A fill 114 may be positioned between the first dam 110 and the second dam 120. In some embodiments, the fill 114 may be an impermeable fill or combination of materials. In some example embodiments, the impermeable fill is at a different height than the height shown in FIG. 1. In some example embodiments, the impermeable fill may be configured to rise. In some example embodiments, the cap covers all of the impermeable fill. In some example embodiments, the cap covers a portion of the impermeable fill.

In some example embodiments, such as the one shown in FIG. 1, a base 132 extends between the first dam and the second dam. The base 132 may include concrete. In alternative embodiments, the base 132 may include a different material.

In some embodiments, such as the one shown in FIG. 1, the cap 130 extends across a width of a waterway 1. In alternative embodiments, a cap 130 may extend across a portion of a width of a waterway 1. In some embodiments, a dam system 100 may include more than one cap, and each cap may extend across a portion of a width of a waterway 1.

The dam system 100 may also include one or more fish passages (not shown in FIG. 1). The dam system 100 may also include one or more recreational passages. Facing may be applied to one or more aspects of the dam system 100. The dam system 100 may also include one or more powerhouses.

In some example embodiments, such as the one shown in FIG. 1 the cap 130 is above the contamination zone 5. In some example embodiments, the cap may also extend below the contamination zone. In some example embodiments, the cap may also extend below the contamination zone and completely surround the contamination zone. In some example embodiments, the cap may also extend below the contamination zone and be directly coupled with the second dam and/or rock bolts at an underground location. In some example embodiments, the cap may also extend below the contamination zone and completely surround at least a portion of the contamination zone and be directly coupled with the second dam and/or rock bolts at an underground location.

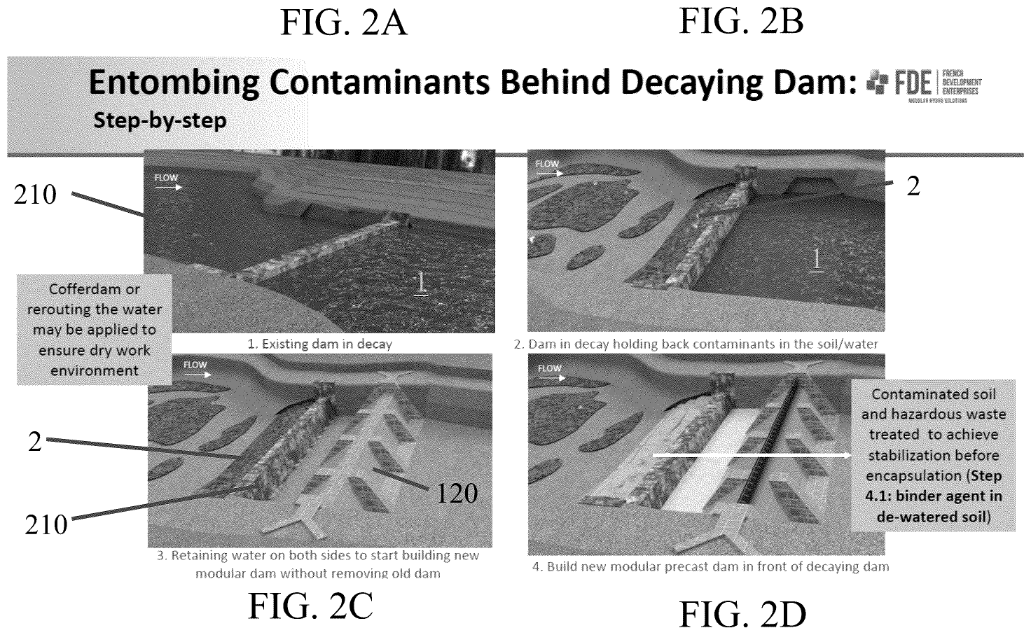

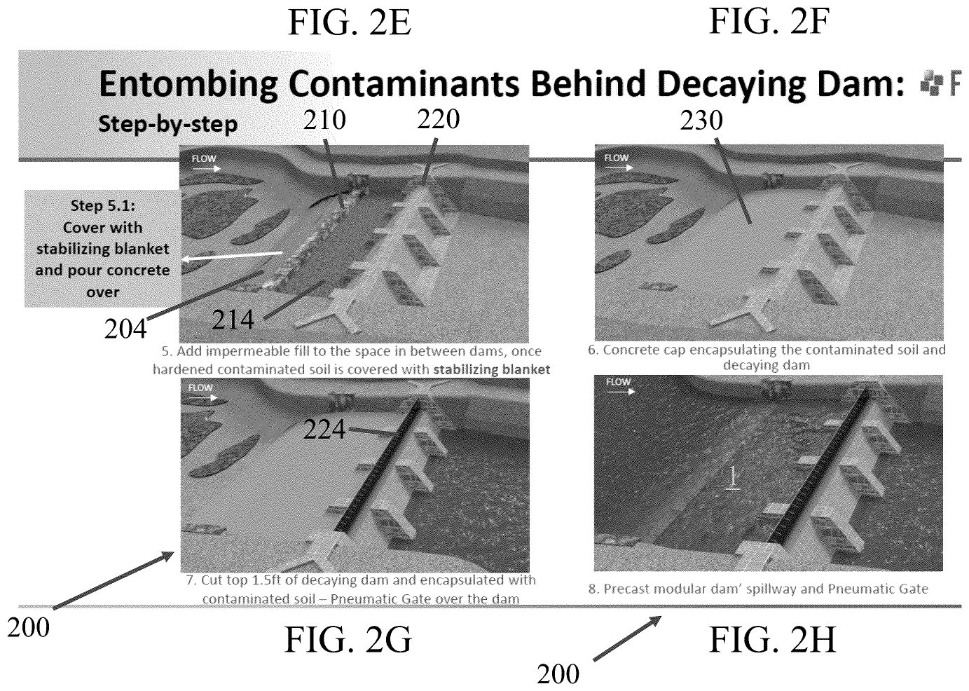

It should be understood that the contamination zone 5 is found in environments depicted in at least some of FIGS. 2A-19B, but the contamination zone 5 is not explicitly shown for simplicity.

FIG. 2A shows an example of a first dam 210 in a waterway 1. Herein, the first dam 210 may also be referred to as an “existing dam,” “preexisting dam,” or “decaying dam.”

FIG. 2B shows an example of a first dam 210 in decay and holding back contaminants or hazardous material 2. Removing the first dam 210 may release the contaminants or hazardous material 2 into the waterway 1, potentially contaminating a water supply.

FIG. 2C shows an example of a first dam 210 holding back contaminants 2, a drained waterway, and an example embodiment of a second dam 220. Rather than removing the first dam 210 and potentially releasing the contaminants, a second dam 220 is constructed nearby. In this embodiment, the second dam includes one or more precast segments.

FIG. 2C shows that water has been retained on both sides of the first and second dams so that the second dam 220 can be constructed. To ensure a dry environment for constructing the second dam 120, water may be re-directed or a cofferdam may be used.

FIG. 2D shows an example embodiment of a second dam 220 in front of a decaying first dam 210. In this view, the contaminants or hazardous waste 2 has been treated (for example, with a binder agent in de-watered soil) to achieve stabilization before entombing.

FIG. 2E shows an example embodiment of a stabilizing blanket 204 (also referred to as a retention fabric) positioned over treated contaminants. Impermeable fill 214 has been positioned between the first dam 210 and the second dam 220.

FIG. 2F shows an example embodiment of a cap 230 entombing the contaminated material 2 and the decaying dam 210. In the embodiment shown in FIG. 2F, the cap 230 includes concrete. In alternative embodiments, the cap 230 may include different material.

A portion of the first dam 210 may be removed before the cap 230 is applied. In the embodiment shown in FIGS. 2F and 2G about 1.5 feet is removed from the first dam 210. In alternative embodiments, a different amount of material may be removed.

FIG. 2G shows an example embodiment of a dam system 200 in which the second dam 220 includes a pneumatic gate 222. In alternative embodiments, the second dam 220 may include a different type of gate, such as a gate driven by an electromagnetic system (not shown).

FIG. 2H shows an example embodiment of a dam system 200 with a second dam 220 in a waterway 1.

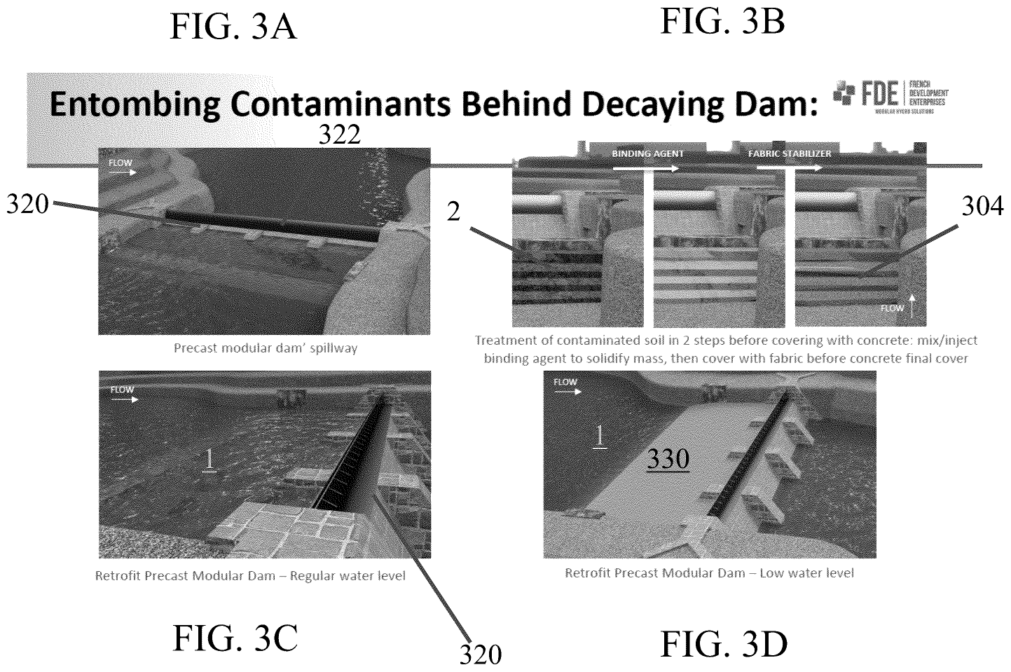

FIG. 3A shows an example embodiment of a second dam 320 in a waterway. In this embodiment, the second dam includes one or more precast segments and a pneumatic gate 322.

FIG. 3B shows an example method for treating contaminated material. The image on the left shows untreated contaminants and/or hazardous material 2. The middle image shows the same location after treatment with a binding agent. The binding agent may be mixed or injected to solidify mass. The right image shows a fabric 304 positioned over the contaminants and/or hazardous material. One or more caps 330 may be applied above the fabric.

FIG. 3C shows an example embodiment of a retrofit precast modular dam (second dam) 320 in a waterway 1 with a regular water level.

FIG. 3D shows an example embodiment of a retrofit precast modular dam (second dam) 320 in a waterway 1 with a low water level.

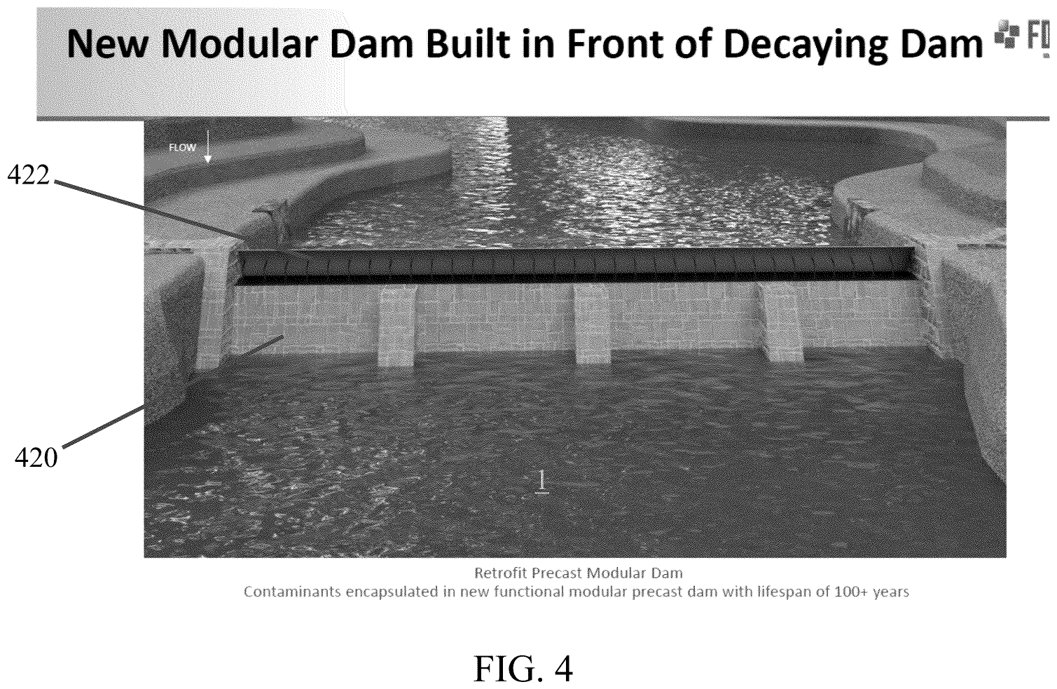

FIG. 4 shows an example embodiment of a second dam 420 with a pneumatic crest gate 422 in a waterway. Additionally, or alternatively, the dam may include a different type of gate.

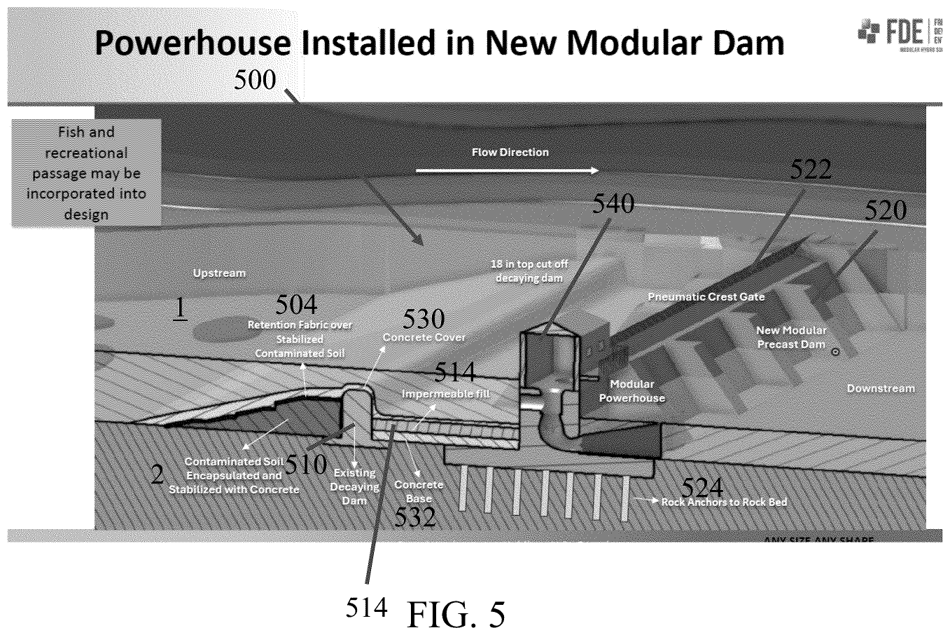

FIG. 5 is a perspective view of an example embodiment of a dam system 500 with a powerhouse 540. The dam system shown in FIG. 5 is similar to the dam system 100 shown in FIG. 1. In some embodiments, such as the one shown in FIG. 5, the dam system 500 includes a cap 530 constructed and arranged to be positioned over a first dam 510. The cap 530 may also entomb treated or untreated contaminants 2 located near the first dam 510. In some example embodiments, at least one retention fabric 504 may be positioned over treated or untreated contaminants. The retention fabric may be positioned below the cap 530.

In some example embodiments, prior to applying the cap 530, a portion of the top of the first dam 510 may be removed. In the embodiment shown in FIG. 5, about 18 inches is removed from the top of the first dam 510. In alternative embodiments, a different amount may be removed. In some embodiments, no material may be removed from the first dam.

The dam system 500 may include a second dam 520. The second dam 520 may include at least one precast segment. A base of the second dam 520 may be coupled to a portion of the cap 530. A base of the second dam 520 may be near a portion of the cap 530. As shown in FIG. 5, the second dam 520 may be coupled to a crest gate 522, for example a pneumatic crest gate.

The embodiment of a dam system 500 shown in FIG. 5 includes a powerhouse 540 constructed and arranged to generate power. The powerhouse 540 may be functionally coupled to the second dam 520. The powerhouse 540 may be structurally coupled to the second dam 520.

The powerhouse 540 includes one or more mechanisms for generating power (for example turbines). In some example embodiments, one or more mechanisms for generating power are functionally coupled to the second dam 520 (i.e., the dam that is not entombed) and these mechanisms are not located in a powerhouse.

A fill 514 may be positioned between the first dam 510 and the second dam 520. In some embodiments, the fill 514 may be an impermeable fill.

In some example embodiments, such as the one shown in FIG. 5, a base 532 extends between the first dam and the second dam. The base 532 may include concrete. In alternative embodiments, the base 532 may include a different material.

In the embodiment shown in FIG. 5 the impermeable fill 514 is at a lower height (relative to the size of the second dam 520) as compared to the height of the fill in the embodiment shown in FIG. 1.

The second dam 520 or the powerhouse 540 may include one or more rock anchors 524, or any similar mechanism, for securing the second dam 520 to a lower surface.

The dam system 500 shown in FIG. 1 may include a powerhouse constructed and arranged to generate power. The powerhouse may be functionally coupled to the second dam 520. The powerhouse 540 may be structurally coupled to the second dam 520. The powerhouse may include one or more rock anchors, or any similar mechanism, for securing the powerhouse to a lower surface.

The dam system 500 may also include one or more fish passages. The dam system 500 may also include one or more recreational passages. Facing may be applied to one or more aspects of the dam system 500.

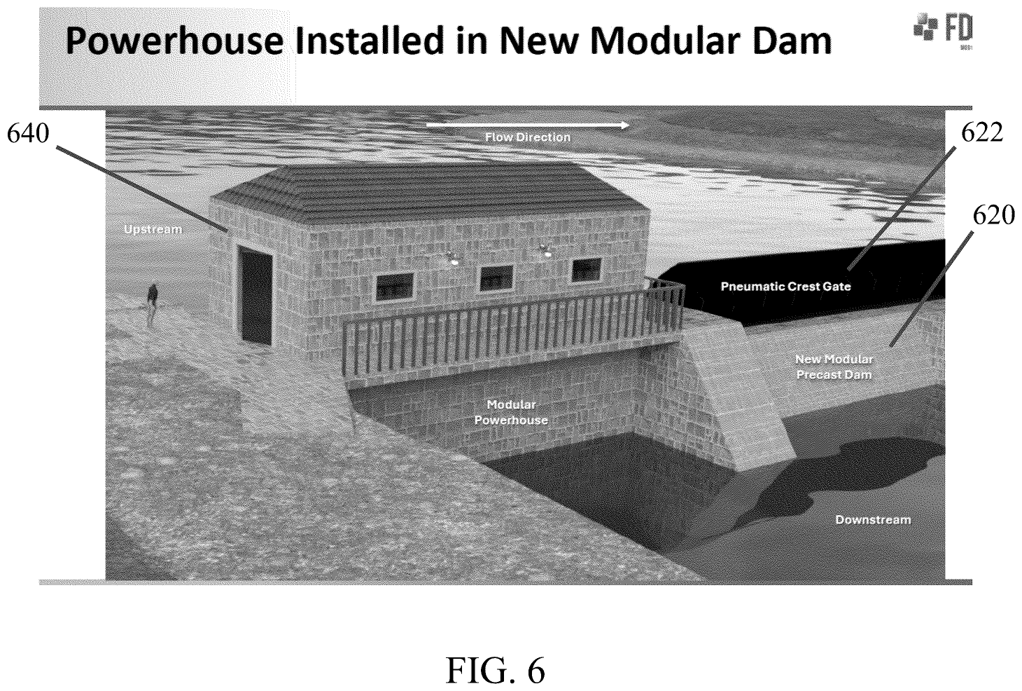

FIG. 6 shows a perspective view from a downstream side of an example embodiment of a powerhouse 640 coupled to a second dam 620 with a pneumatic crest gate 622. In some embodiments, such as the one shown in FIG. 6 the powerhouse includes one or more precast segments and has a modular construction.

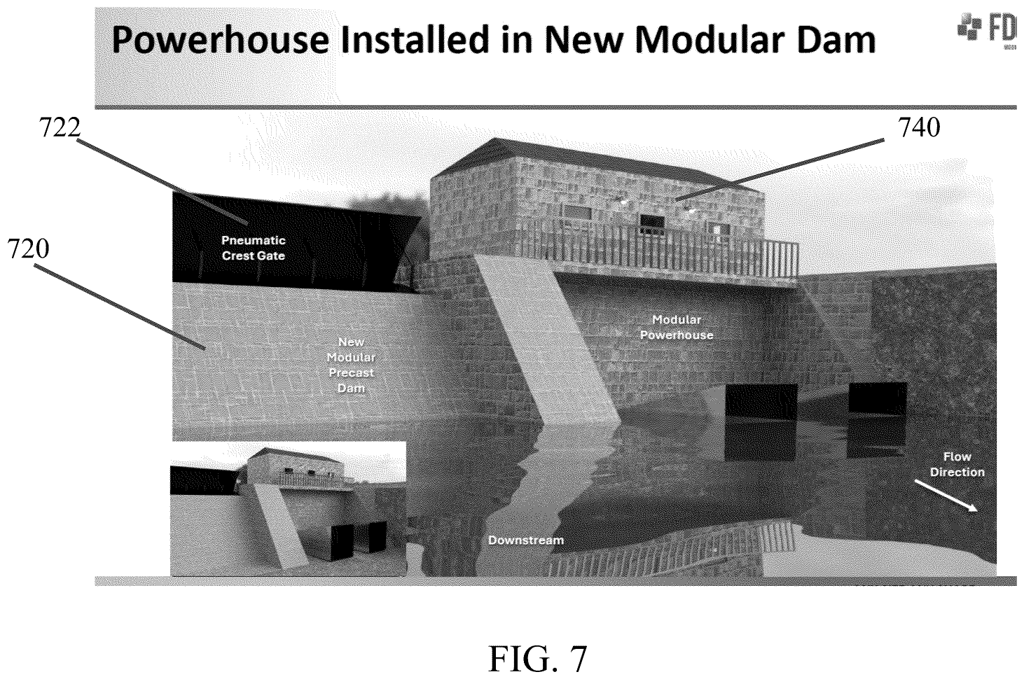

FIG. 7 shows a perspective view from a downstream side of an example embodiment of a powerhouse 740 coupled to a second dam 720 with a pneumatic crest gate 722.

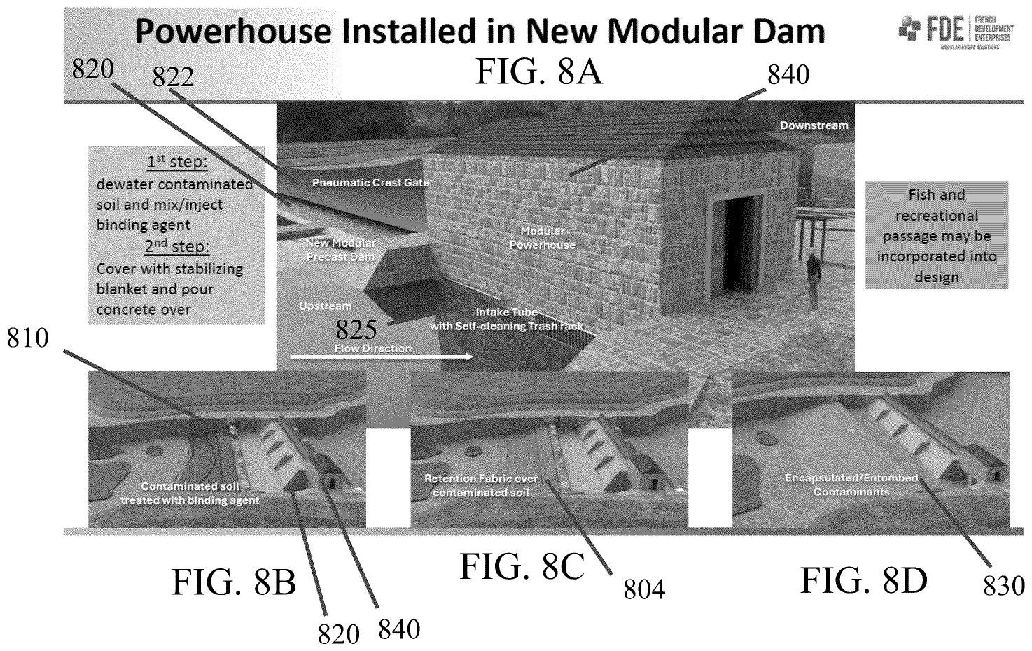

FIG. 8A shows a perspective view from an upstream side of an example embodiment of a powerhouse 840 coupled to a second dam 820 with a pneumatic crest gate 822. In this embodiment, the powerhouse 840 includes an intake tube with a self-cleaning trash rack 825.

FIG. 8B shows an example embodiment of a first dam 810 near contaminated material and a second dam 820 coupled to a powerhouse 840.

FIG. 8C shows the example embodiment from FIG. 8B with a retention fabric 804 over the contaminated material.

FIG. 8D shows the example embodiment from FIG. 8C with a cap 830 over the retention fabric 804.

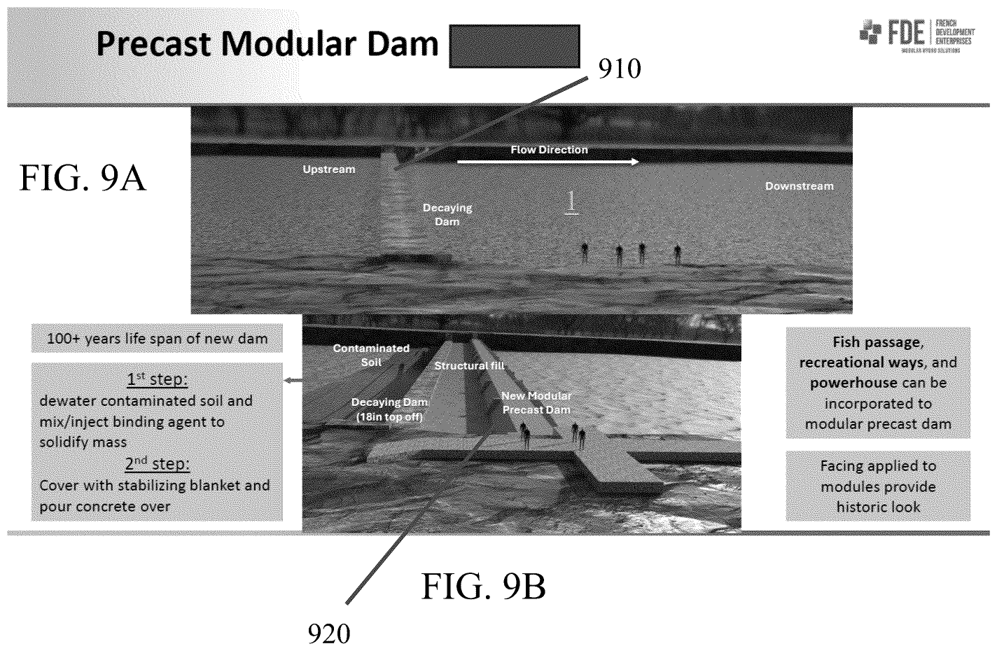

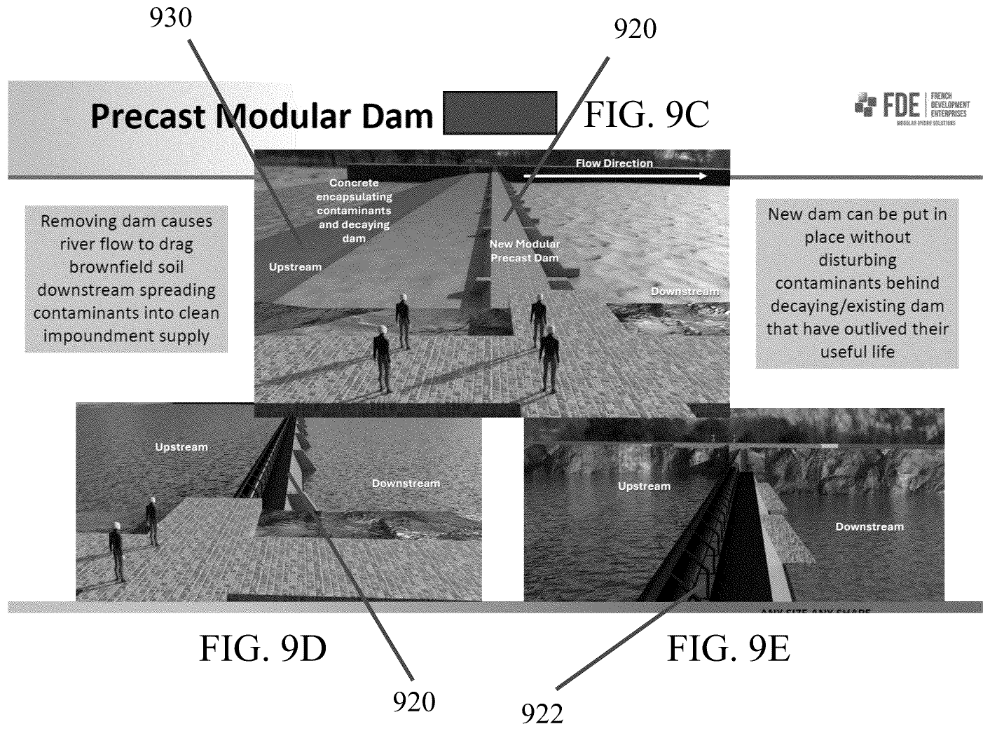

FIG. 9A shows a decaying first dam 910 in a waterway 1.

FIG. 9B shows an example of a drained waterway with contaminants near a decaying first dam and a new second dam 920. In some embodiments, the second dam 920 may be 1500 feet high. In alternative embodiments, the second dam 920 may be a different height.

FIG. 9C shows an example of a drained waterway with a new modular precast dam 920 and a cap 930, the cap 930 entombing contaminants and a decaying dam.

FIG. 9D shows an example of a new modular precast dam 920 in a waterway.

FIG. 9E shows an example of a new modular precast dam 920 with a pneumatic crest gate 922 in a waterway.

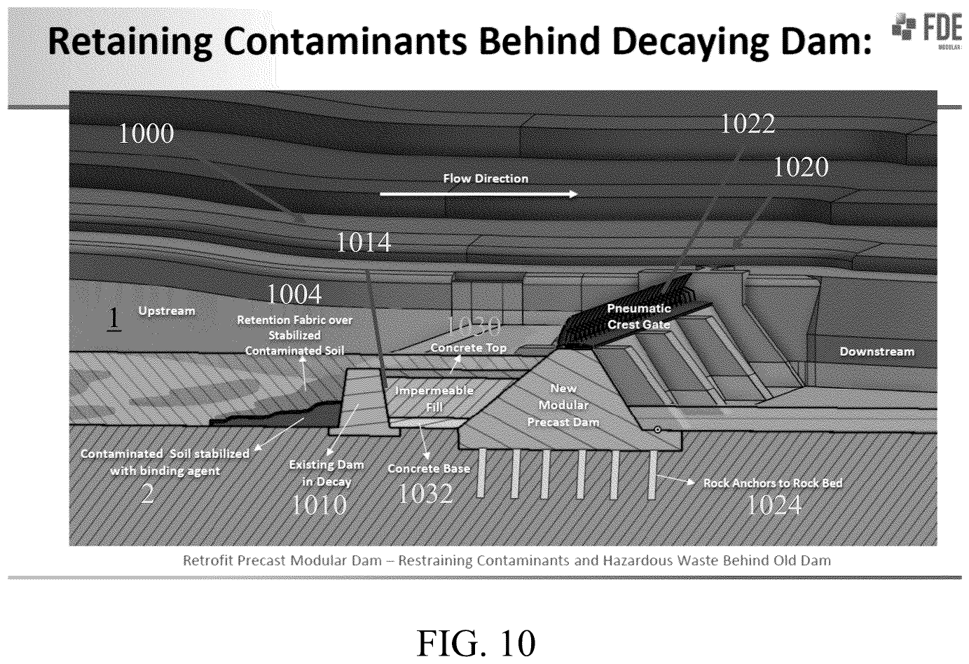

FIG. 10 shows an example embodiment of a dam system 1000 that includes a new modular precast dam 1020, and contaminants 2 are retained behind a decaying dam 1010. In some embodiments, such as the one shown in FIG. 10, the dam system 1000 includes a cap 1030 constructed and arranged to be positioned over a first dam 1010. In alternative embodiments, the cap 1030 is constructed and arranged to be positioned between the first dam 1010 and the second dam 1020.

In some example embodiments, at least one retention fabric 1004 may be positioned over treated or untreated contaminants 2.

In some example embodiments, prior to applying the cap 1030, a portion of the top of the first dam 1010 may be removed. In the embodiment shown in FIG. 10, about 18 inches is removed from the top of the first dam 1010. In alternative embodiments, a different amount may be removed. In some embodiments, no material may be removed from the first dam.

The dam system 1000 may include a second dam 1020. The second dam 1020 may include at least one precast segment. A base of the second dam 1020 may be coupled to a portion of the cap 1030. A base of the second dam 1020 may be near a portion of the cap 1030. As shown in FIG. 10, the second dam 1020 may be coupled to a crest gate 1022, for example a pneumatic crest gate.

A fill 1014 may be positioned between the first dam 1010 and the second dam 1020. In some embodiments, the fill 1014 may be an impermeable fill.

In some example embodiments, such as the one shown in FIG. 10, a base 1032 extends between the first dam and the second dam. The base may include concrete or a different material.

The second dam 1020 may include one or more rock anchors 1024, or any similar mechanism, for securing the second dam 1020 to a lower surface.

The dam system 1000 shown in FIG. 10 may include a powerhouse constructed and arranged to generate power. The powerhouse may be functionally coupled to the second dam 1020. The powerhouse may be structurally coupled to the second dam 1020. The powerhouse may include one or more rock anchors, or any similar mechanism, for securing the powerhouse to a lower surface.

The dam system 1000 may also include one or more fish passages. The dam system 1000 may also include one or more recreational passages. Facing may be applied to one or more aspects of the dam system 1000.

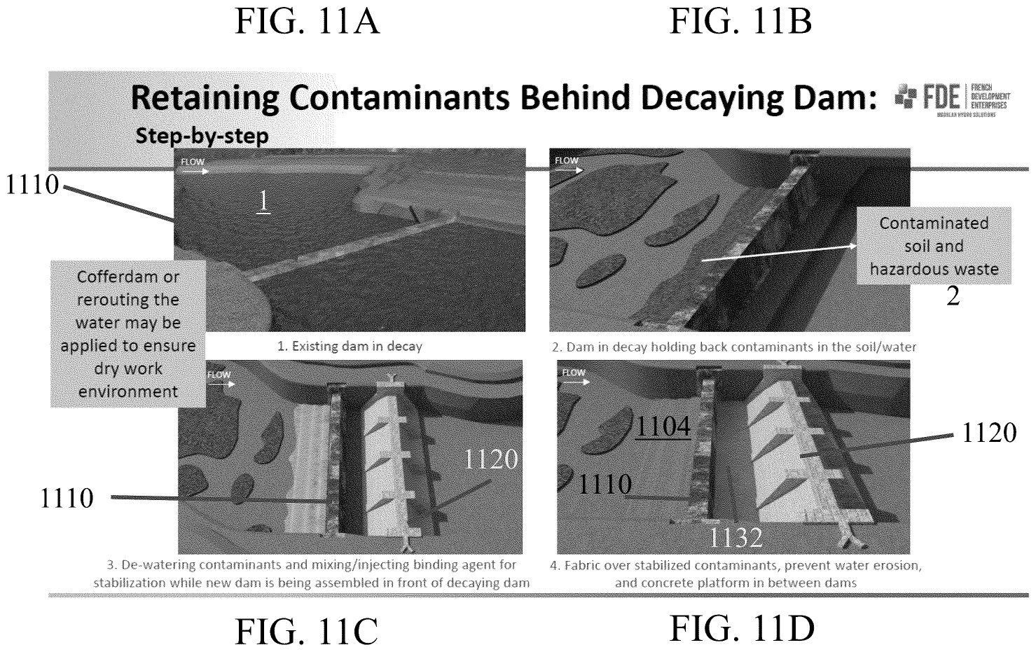

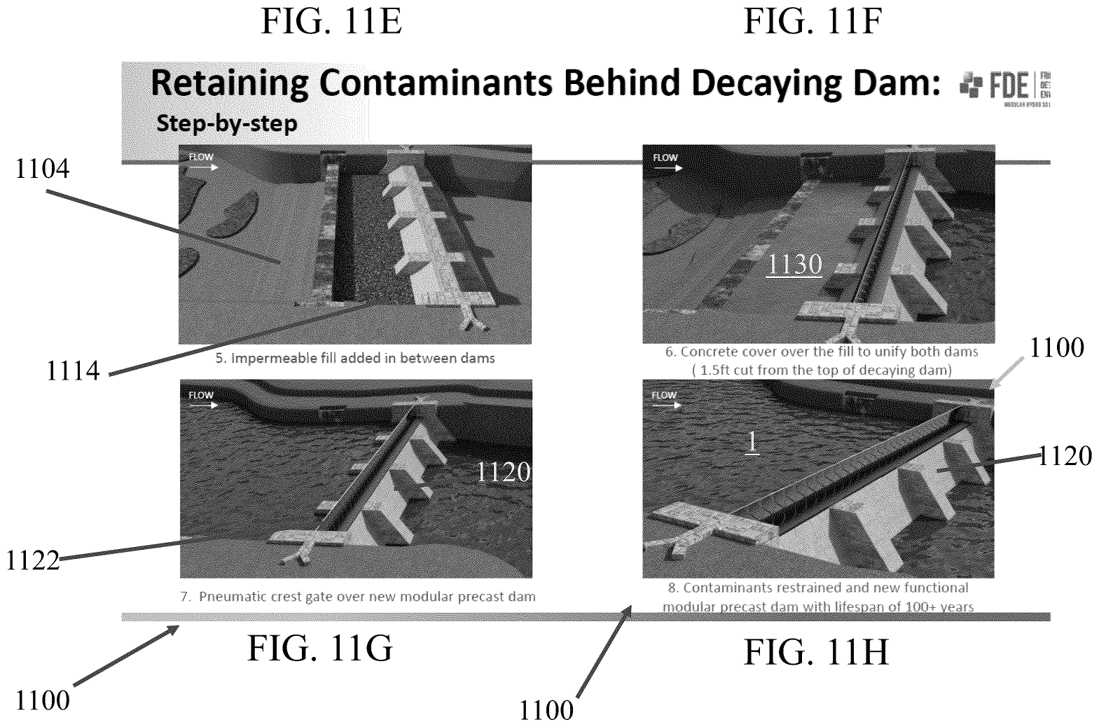

FIG. 11A shows an example of an existing dam (a first dam) 1110 in a waterway 1.

FIG. 11B shows an example of a first dam 1110 in decay and holding back contaminants or hazardous material 2 in the soil. Removing the first dam 1110 may release the contaminants or hazardous material into the waterway, potentially contaminating a water supply.

FIG. 11C shows an example of a first dam 1110 holding back contaminants 2, a drained waterway, and an example embodiment of a second dam 1120. Rather than removing the first dam 1110 and potentially releasing the contaminants into a waterway, a second dam 1120 is constructed nearby. FIG. 11C shows that water has been retained on both sides of the first and second dams so that the second dam can be constructed. Redirecting water or using cofferdam may be applied to ensure a dry environment for constructing the second dam 1120. In some embodiments, a binding agent is mixed or injected into the contaminants for stabilization while the new dam is being assembled in front of the decaying dam.

FIG. 11D shows an example embodiment of a second dam 1120 in front of a decaying first dam 1110. In this view, the contaminated soil and hazardous waste 2 has been treated (for example, with a binder agent in de-watered soil) to achieve stabilization before entombing. At least one fabric 1104 is positioned over the stabilized contaminants to prevent water erosion and a concrete platform 1132 is positioned between the dams. In alternative embodiments the platform 1132 may include a different material.

FIG. 11E shows an example embodiment of a stabilizing blanket 1104 positioned over treated contaminants. Impermeable fill 1114 has been positioned between the first dam 1110 and the second dam 1120.

FIG. 11F shows an example embodiment of a cap 1130 entombing the fill 1114 and level with a top of the decaying dam 1110. In alternative embodiments, the cap 1130 may not be exactly level with the top of the first dam 1110.

In the embodiment shown in FIG. 11F, the cap 1130 includes concrete. In alternative embodiments, the cap 1130 may include different material.

A portion of the first dam 1110 may be removed before the cap 1130 is applied. In the embodiment shown in FIG. 11F about 1.5 feet is removed from the first dam 1110. In alternative embodiments, a different amount of material may be removed.

FIG. 11G shows an example embodiment of a dam system 1100 in which the second dam 1120 includes a pneumatic gate 1122. In alternative embodiments, the second dam 1120 may include a different type of gate.

FIG. 11H shows an example embodiment of a dam system 1100 with a second dam 1120 in a waterway 1.

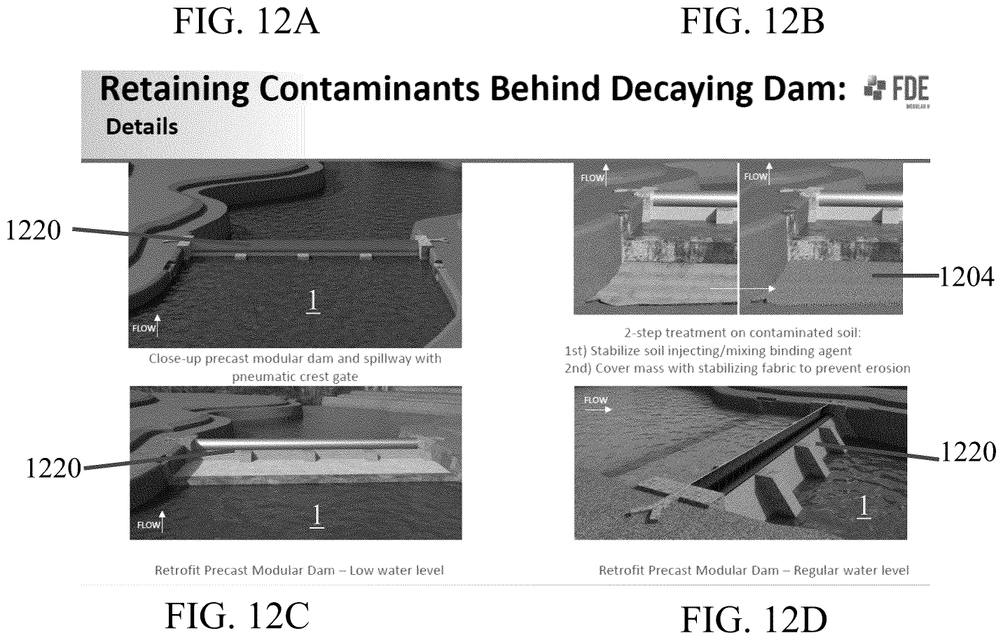

FIG. 12A shows an example modular precast dam 1220 in a waterway 1.

FIG. 12B shows an example of the two-step treatment of contaminated material. First, the contaminated material is stabilized by injecting or mixing a binding agent. Next, the contaminated material is covered with at least one stabilizing fabric 1204 to prevent erosion.

FIG. 12C shows an example embodiment of a precast modular dam 1220 in a waterway with a low water level after the contaminated material has been secured.

FIG. 12D shows an example embodiment of a precast modular dam 1220 in a waterway 1 with a regular water level after the contaminated material has been secured.

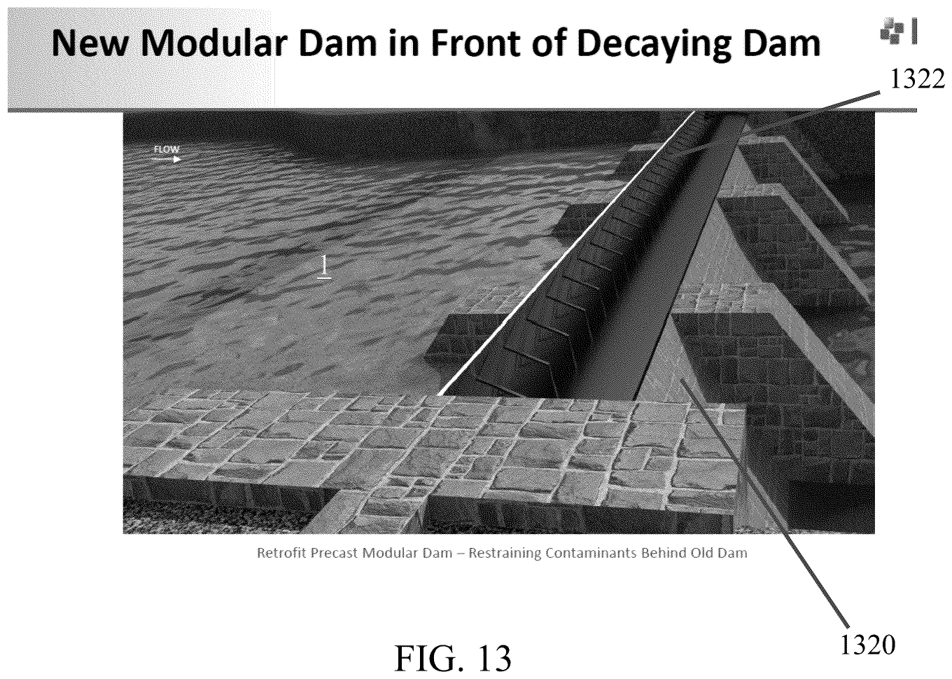

FIG. 13 shows an example embodiment of a modular precast dam 1320 in front of decaying dam and restraining the contaminants behind the decaying dam. In the embodiment shown in FIG. 13, the precast dam 1320 includes a pneumatic crest gate 1322. Additionally, or alternatively, the dam may include a different type of gate, such as an electromagnetically driven gate or motorized gate.

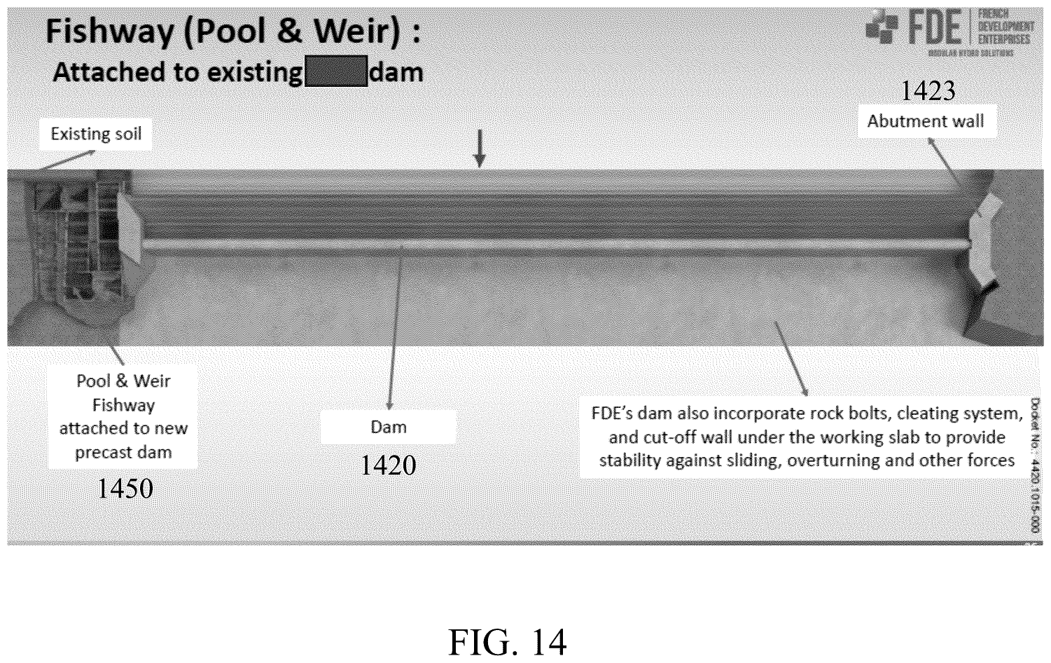

FIG. 14 shows an example embodiment of a second dam 1420 with precast segments that is coupled to a fishway 1450. In the embodiment shown in FIG. 14, the fishway 1450 is a pool and weir fishway, which is a series of interconnected pools separated by low weirs. In alternative embodiments, the second dam 1420 may be coupled to a different type of fishway.

In some example embodiments, such as the embodiment shown in FIG. 14, the second dam 1420 is coupled to an abutment wall 1423. In some example embodiments, the second dam 1420 may employ rock bolts for stability. In some example embodiments, the second dam 1420 may define a cleating system (not shown) in the form of alternating adjacent features (e.g., precast segments) that interface to the riverbed. The second dam 1420 may define or be coupled to a cutoff wall. The second dam 1520 may be coupled to and deployed on a working slab that is constructed, at least in part, on a riverbed.

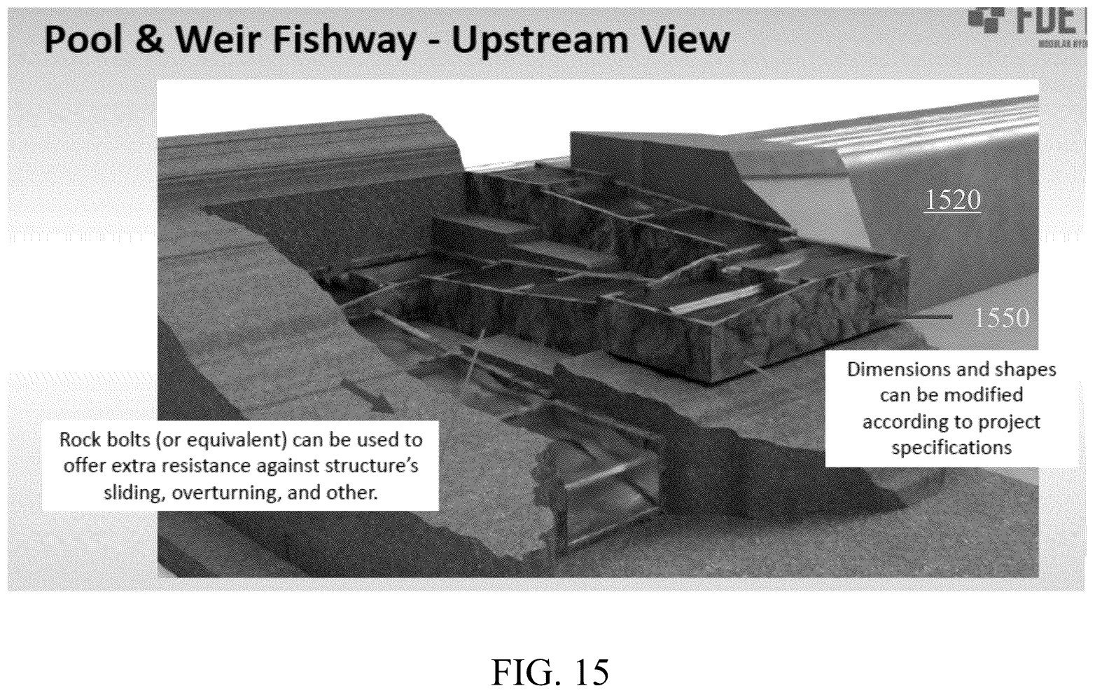

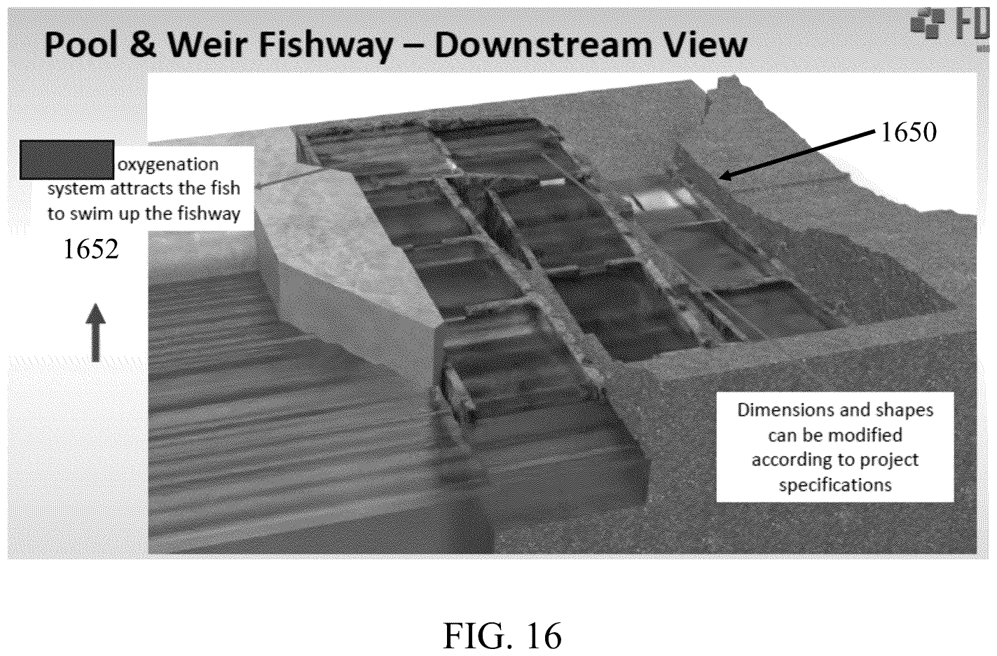

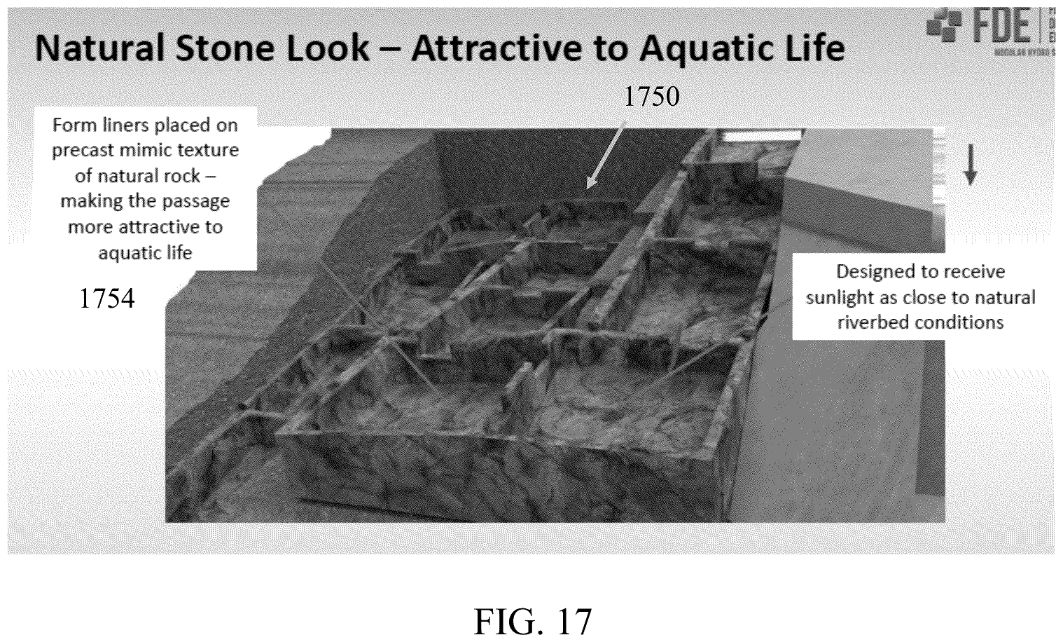

FIG. 15 shows an upstream view of an example embodiment of a pool and weir fishway coupled to a second dam 1520. The fishway 1550 may include multiple precast segments. In some embodiments, the fishway 1550 may be coupled to one or more rock bolts (or equivalent) to prevent the fishway from sliding and/or overturning. In alternative embodiments, the size and/or shape of the fishway may be different and may be designed as a function of local features of the waterway in combination with features of the preexisting or new dam or structure entombing the contaminated soil or other material.

FIG. 16 shows a downstream view of an example embodiment of a pool & weir fishway 1650 coupled to a second dam and including an oxygenation attraction system 1652. The fishway 1450 may include multiple precast segments. The attraction system 1652 may attract the fish to swim up the fishway.

FIG. 17 shows an example embodiment of a fishway 1750 coated with liner 1754 to mimic the texture of natural rock. The fishway 1450 may be constructed of multiple precast segments.

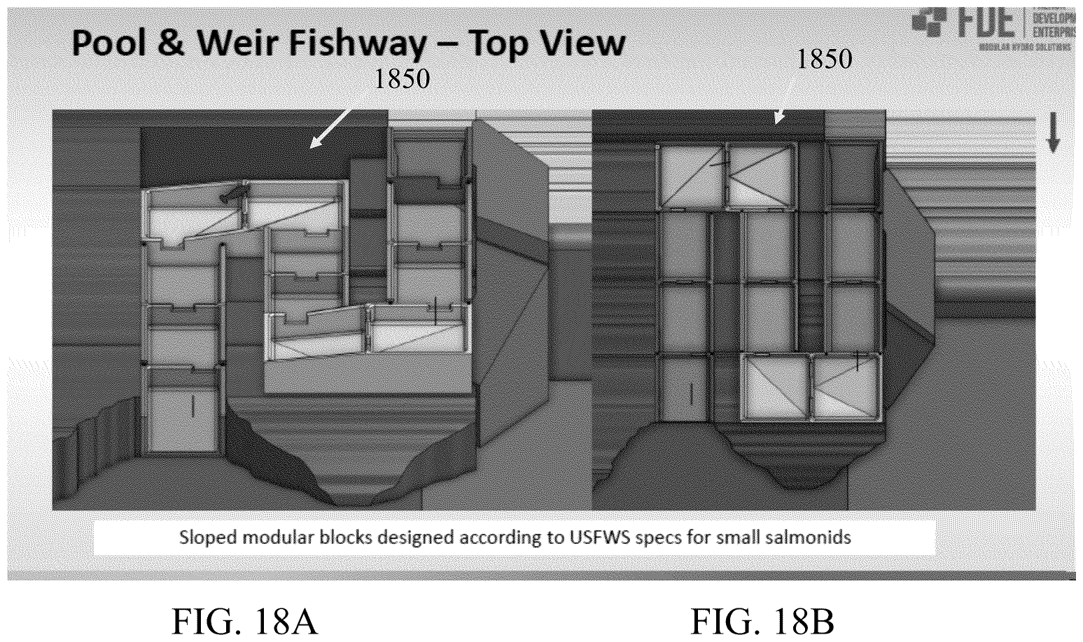

FIG. 18A is a perspective view of an example embodiment of a fishway 1850 with sloped modular blocks designed according to the U.S. Fish and Wildlife Service (USFWS) specifications for small salmonids.

FIG. 18B is a top view of an example embodiment of a fishway 1850 with modular blocks designed according to USFWS specifications for small salmonids.

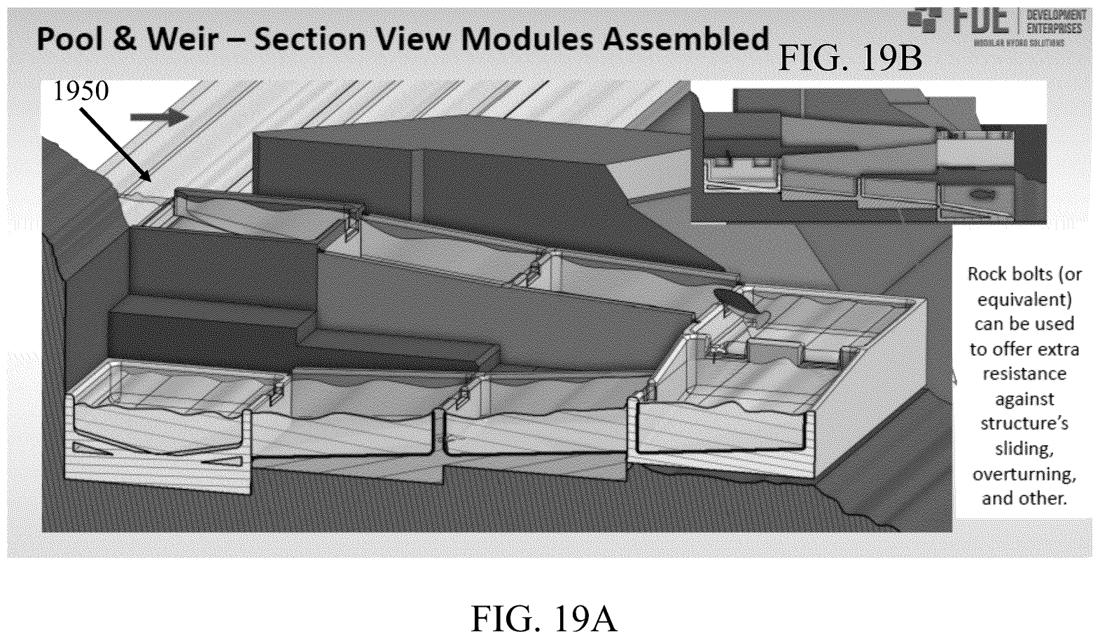

FIG. 19A is a perspective view of an example embodiment of a fishway 1950.

FIG. 19B is a side view of an example embodiment of a fishway 1950. Rock bolts (or the equivalent) may be used to offer extra resistance against the fishway's sliding or overturning.

A dam system may include one or more mechanisms for filtering contaminated material near a decaying dam. In some embodiments, the dam system may include one or more filter modules (not shown) constructed and arranged to filter contaminated material. The filter modules may be portable. The filter modules may be positioned in trailers. The filter modules may be positioned in trailers that include precast segments. The filter modules may be positioned in housings that include precast segments.

The filter modules may include filters with different filtering strength. The filter modules may be able to provide real-time data regarding filter replacement and/or water quality. The filters may have intakes located at and upstream of the newly constructed dam in calm water formed between the preexisting dam or encapsulated version thereof.

In some example embodiments, a second dam may be constructed by first positioning a first series of modular, precast forms that include a cavity near the location of the cap. As concrete is poured to form the cap, the concrete may fill the cavity in the precast forms. Additional modular and/or precast forms may be stacked on the first layer of precast forms, thereby building the second dam.

### Definitions

The terms “contaminants,” “contaminated material,” “hazardous waste,” and “hazardous material” may be used interchangeably. The contaminants or hazardous waste may include soil or other material. Example contaminants may include industrial waste, oil, chemicals, brownfield erosion contaminants, or pentachlorophenols.

The terms “river” or “waterway” as used herein, refers to a river, stream, canal, or other man-made or natural waterway.

The terms “at least a portion of” could refer to an entire entity or less than an entire entity. For example, at least a portion of a contamination zone could refer to the entire contamination zone, some portion of a contamination zone as defined by distance, or some portion of a contamination zone as defined by concentration. The contamination zone may be defined by a measurable parameter, for example, distance or concentration.

The term “entomb contaminants” means to bury the contaminants in such a manner than the contaminants cannot contaminate surrounding water beyond a threshold. The threshold may be zero, i.e., no contaminates that are entombed contaminate the surrounding water.

The surrounding water may not completely surround the cap.

The terms “binding agent” and “binder agent” are used interchangeably herein.

A preexisting structure may include a dam, natural formation, former or existing mill building or portion thereof. The boundaries of a contamination zone are determined by a measurable characteristic, for example the concentration of a contaminant or contaminants or a distance.

The teachings of all patents, published applications, and references cited herein are incorporated by reference in their entirety.

The features and/or characteristics associated with any embodiment shown or described may be combined with any other embodiment. Features and/or characteristics may be any size or any shape.

While example embodiments have been particularly shown and described, it will be understood by those skilled in the art that various changes in form and details may be made therein without departing from the scope of the embodiments encompassed by the appended claims.

What is claimed is:

1. A dam system for entombing contaminants in a river, the dam system comprising:
a preexisting structure in the river having associated therewith a contamination zone defined by a location of contaminants;
a dam constructed upriver or downriver of the preexisting structure; and
a cap coupled to the preexisting structure and the dam, the cap spanning and entombing the contaminants in at least a portion of the contamination zone.

2. The dam system of claim 1, wherein the preexisting structure includes a preexisting dam.

3. The dam system of claim 1, wherein the cap extends from a first riverbank to a second riverbank, the first riverbank and the second riverbank being on different sides of the river.

4. The dam system of claim 1, wherein the dam includes at least one precast segment.

5. The dam system of claim 1, wherein the cap includes at least one precast segment.

6. The dam system of claim 1, further comprising a stabilizing blanket, the stabilizing blanket being positioned between the cap and the contaminants.

7. The dam system of claim 1, wherein a region between the preexisting structure and the dam includes an impermeable fill.

8. The dam system of claim 7, wherein the cap is positioned over at least a portion of the impermeable fill.

9. The dam system of claim 1, wherein the dam includes a pneumatic crest gate.

10. The dam system of claim 1, further comprising a powerhouse, the powerhouse being functionally coupled with the dam.

11. The dam system of claim 1, further comprising a fish ladder associated with the dam.

12. A method for entombing contaminants in a river, the method comprising:
constructing a dam adjacent to a preexisting structure; and
applying a cap over the preexisting structure and contaminants associated with the preexisting structure to entomb the contaminants in the river, the applying the cap including:
coupling a first end of the cap to a riverbed; and
coupling a second end of the cap to the dam.

13. The method of claim 12, wherein the dam includes at least one precast segment.

14. The method of claim 12, further comprising stabilizing the contaminants using a binding agent.

15. The method of claim 12, further comprising covering the contaminants with a stabilizing blanket.

16. The method of claim 12, further comprising adding impermeable fill between the preexisting structure and the dam.

17. The method of claim 12, further comprising functionally coupling the dam with a powerhouse.

18. The method of claim 12, further comprising assembling a fish ladder or other animal passageway at the dam to enable fish or other animals to travel upriver and downriver of the dam.

19. The method of claim 12, further comprising removing a top portion of the preexisting structure before applying the cap.

20. A dam system for entombing contaminants in a river, the dam system comprising:
a dam coupled to a riverbed and obstructing water flow for at least a portion of a width of a river, the dam being adjacent to a preexisting structure and contaminants; and
means for entombing the contaminants.
